(19) United States
(12) Patent Application Publication
(10) Pub. No.: US 2026/0304330 A1
(43) Pub. Date: Oct. 1, 2026

(54) METHOD FOR POWER HEADROOM REPORT WITH DYNAMIC WAVEFORM SELECTION FOR UPLINK MULTI-PANEL TRANSMISSION

(71) Applicant: Google LLC, Mountain View, CA (US)

(72) Inventors: Yushu ZHANG, Beijing (CN); Kao-Peng CHOU, Taipei City (TW)

(21) Appl. No.: 19/480,364

(22) PCT Filed: May 15, 2023
(86) PCT No.: PCT/CN2023/094151

§ 371 Date: Oct. 30, 2025

(51) Int. Cl. H04W 52/36; H04W 52/14

(52) U.S. Cl. CPC H04W 52/365; H04W 52/146

(57) ABSTRACT

This disclosure provides systems, devices, apparatus, and methods, including computer programs encoded on storage media, for a UE to report power headroom associated with dynamic waveform selection for uplink multi-panel transmission. The UE may calculate and report UE-specific power headroom report (PHR) for one or more combinations of waveforms from the multiple antenna panels or panel-specific PHR for one or more waveforms for each panel. The UE (102) receives (410), from the network entity (104), a signaling for configuring at least one power headroom report (PHR) to support dynamic waveform indication in uplink multi-panel transmission. The UE (102) transmits (1012), to the network entity (104), the at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

### TECHNICAL FIELD

The present disclosure relates generally to wireless communication, and more particularly, to techniques for a user equipment (UE) to calculate and report power headroom (PHs) associated with uplink transmissions from multiple antenna panels when the UE supports dynamic indication of multiple waveforms for the uplink transmissions.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a 5G-RAN may configure uplink power control parameters to limit intracell and intercell interference and to reduce the UE power consumption in an open-loop or closed-loop power control scheme. The UE may transmit to the 5G-RAN power headroom reports (PHRs) based on the uplink power control parameters for the 5G-RAN to dynamically indicate the waveforms of scheduled uplink multi-panel transmission. However, mechanisms in UEs to support PHRs for dynamic waveform indication in uplink multi-panel transmission may be complicated, resulting in lower system performance.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In multi-panel codebook transmission, a UE may transmit a set of non-precoded sounding reference signals (SRS) from multiple antenna panels (or simply panels) for a network entity, such as a base station, to measure the uplink propagation channels from the multiple antenna panels. For example, in a UE with two antenna panels, the network entity may configure two sets of SRS resources for UE transmissions of SRS for uplink channel state information (CSI) measurements, one from each antenna panel. The network entity may evaluate the SRS transmissions belonging to each SRS resource to select an antenna panel for the physical uplink shared channel (PUSCH) and to determine an appropriate transmission rank (number of transmission layers) and precoding weights (precoding matrix) from a standardized codebook to maximize the received signal to noise ratio. The network entity may use downlink control information (DCI) to allocate PUSCH resources, and to instruct the UE to use one or more antenna panels, and a specific combination of transmission layers and precoding matrix for the PUSCH).

The network entity may also configure uplink power control parameters for SRS, PUSCH and physical uplink control channel (PUCCH) to limit intracell and intercell interference, and to reduce the UE power consumption in an open-loop or closed-loop power control scheme. For example, the network entity may configure uplink power control parameters such as P0, α, pathloss reference signals (synchronization signal block (SSB) or downlink CSI reference signal), closed-loop power control index, etc., to control the transmit power of the SRS, PUSCH, and PUCCH based on transmission configuration indicator (TCI) or spatial relation information.

The UE may transmit to the network entity power headroom reports (PHRs) to report the power headroom (PH) of PUSCH (Type1 PH) or SRS (Type3 PH) using medium access control control element (MAC-CE) on the PUSCH to facilitate uplink scheduling. For example, if the UE has a scheduled PUSCH or SRS transmission, the UE may calculate the PH as the difference between the actual maximum transmission power and the actual transmission power for the PUSCH or SRS, where the actual transmission power is determined based on the uplink power control parameters for the PUSCH or SRS. If the UE does not have a scheduled PUSCH or SRS transmission, the UE may determine the PH based on the difference between a reference maximum transmission power and reference transmission power based on a default set of power control parameters.

The network entity may use the PHR to identify the number of resource blocks to be allocated to the PUSCH, to identify the modulation and coding scheme, and for other radio resource management functions. The network entity may also use the PHR to dynamically indicate the waveform of a scheduled PUSCH transmission when allocating PUSCH resources. For example, a scheduling DCI may indicate whether the PUSCH waveform is cyclic prefix based orthogonal frequency division multiplexing (CP-OFDM) or Discrete Fourier transform spread based OFDM (DFT-s-OFDM). The maximum transmission power for the two waveforms may be different due to the higher peak average power ratio (PAPR) or cubic metric (CM) of the CP-OFDM compared to that of the DFT-s-OFDM. Furthermore, in CP-OFDM and DFT-s-OFDM based multi-panel PUSCH transmission, especially for PUSCH transmissions scheduled by multiple DCIs, the PUSCH transmissions from the multiples antenna panels may have various combination of identical or different waveforms.

Aspects of the present disclosure address the above-noted and other complications for reporting power headroom when the UE supports dynamic waveform indication of PUSCH in uplink multi-panel transmission. The network entity may configure uplink power control parameters for different waveform or combinations of waveforms. In some aspects, the UE may calculate and report UE-specific PHR for one or more combinations of waveforms from the multiple antenna panels. The UE may report the PHR based on a UE-specific maximum uplink transmission power for one or more waveform combinations and the total actual or reference transmission power corresponding to a specific waveform combination from multiple antenna panels. In some aspects, the UE may calculate and report panel-specific PHR for one or more waveforms for each of the multiple antenna panels. The UE may report the PHR based on the panel-specific maximum uplink transmission power for one or more waveforms and the actual or reference transmission power for a corresponding waveform for each antenna panel.

According to some aspects, a UE receives, from a network entity, a signaling for configuring at least one PHR to support dynamic waveform indication in uplink multi-panel transmission. The UE transmits, to the network entity, the at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

According to some aspects, a network entity transmits, to a UE, a signaling for configuring at least one PHR to support dynamic waveform indication in uplink multi-panel transmission. The network entity receives, from the UE, the at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

### BRIEF DESCRIPTION OF THE DRAWINGS

FIG. 1 illustrates a diagram of a wireless communications system that includes a plurality of user equipment (UEs) and network entities in communication over one or more cells.

FIG. 2 is a diagram illustrating that a UE is configured to transmit a CP-OFDM waveform from two antenna panels when the UE supports dynamic waveform indication of PUSCH in uplink multi-panel transmission.

FIG. 3 is a diagram illustrating that a UE is configured to transmit a DFT-s-OFDM waveform from two antenna panels when the UE supports dynamic waveform indication of PUSCH in uplink multi-panel transmission.

FIG. 4 is a diagram illustrating that a UE is configured to transmit a CP-OFDM waveform from a first antenna panel and to transmit a DFT-s-OFDM waveform from a second antenna panel when the UE supports dynamic waveform indication of PUSCH in uplink multi-panel transmission.

FIG. 5 is a signaling diagram illustrating communications between a UE and a network entity for the UE to report power headroom when the UE supports dynamic waveform indication in uplink multi-panel transmission.

FIG. 6 shows two diagrams illustrating a single UE-specific PHR based on one combination of waveforms of the dynamic waveform indication from two antenna panels in uplink multi-panel transmission.

FIG. 7 shows two diagrams illustrating multiple UE-specific PHRs based on different combinations of waveforms of the dynamic waveform indication from two antenna panels in uplink multi-panel transmission.

FIG. 8 shows two diagrams illustrating a single panel-specific PHR based on one waveform of the dynamic waveform indication from each antenna panel in uplink multi-panel transmission.

FIG. 9 shows two diagrams illustrating multiple panel-specific PHRs based on different waveforms of the dynamic waveform indication from each antenna panel in uplink multi-panel transmission.

FIG. 10 is a flowchart of a method of wireless communication at a UE for reporting power headroom when the UE supports dynamic waveform indication in uplink multi-panel transmission.

FIG. 11 is a flowchart of a method of wireless communication at a network entity for receiving a power headroom report when a UE supports dynamic waveform indication in uplink multi-panel transmission.

FIG. 12 is a diagram illustrating a hardware implementation for an example UE apparatus.

FIG. 13 is a diagram illustrating a hardware implementation for one or more example network entities.

### DETAILED DESCRIPTION

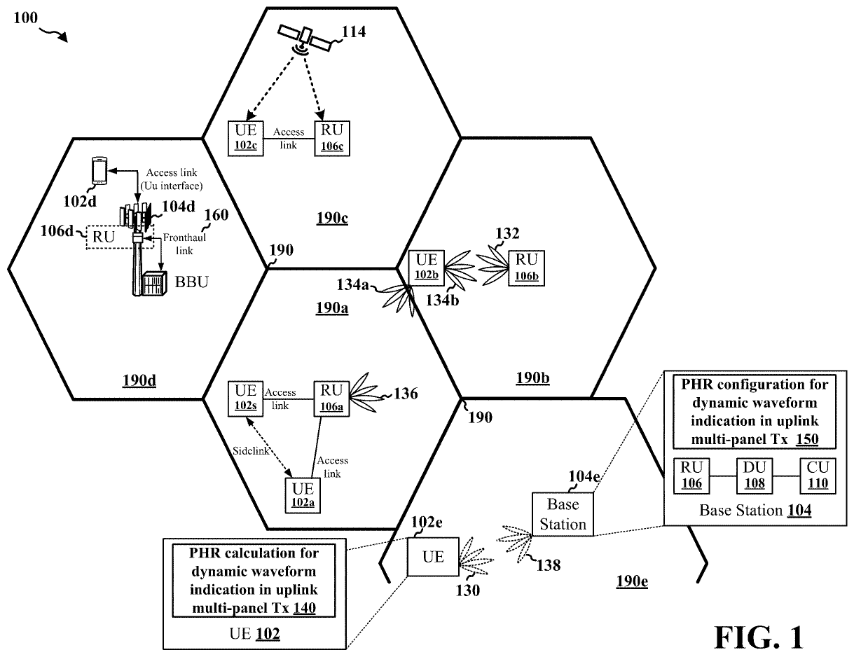

FIG. 1 illustrates a diagram 100 of a wireless communications system associated with a plurality of cells 190. The wireless communications system includes user equipment (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a PHR calculation for dynamic waveform indication in uplink multi-panel transmission component 140 (also referred to as “PHR calculation component 140”) that is configured to trigger, calculate, and report power headroom for multiple antenna panels whose uplink transmission waveforms may be dynamically indicated. The PHR calculation component 140 may receive from the base station/network entity 104 a signaling for configuring at least one PHR to support dynamic waveform indication in uplink multi-panel transmission. The PHR calculation component 140 may transmit to the base station/network entity 104 at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

In certain aspects, any of the base stations 104 or a network entity of the base stations 104 may include a PHR configuration for dynamic waveform indication in uplink multi-panel transmission component 150 (also referred to as “PHR configuration component 150”) that is configured to receive PHRs from multiple antenna panels of a UE whose uplink transmission waveforms may be dynamically indicated. The PHR configuration component 150 may transmit to any of the UEs 102 a signaling for configuring at least one PHR to support dynamic waveform indication in uplink multi-panel transmission. The PHR configuration component 150 may receive from any of the UEs at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

For uplink multi-panel transmission, a network entity 104 may dynamically indicate the waveform of the PUSCH as cyclic prefix based orthogonal frequency division multiplexing (CP-OFDM) or Discrete Fourier transform spread based OFDM (DFT-s-OFDM), by the scheduling downlink control information (DCI) that allocates PUSCH resources. DFT-s-OFDM uses transform precoding of the DFT operation to spread the modulation symbols prior to mapping onto a set of subearriers. DFT-s-OFDM has a lower peak-to-average power ratio (PAPR) than CP-OFDM. This may allow the UE 102 to transmit with a higher average power using DFT-s-OFDM and so improves the uplink coverage performance while CP-OFDM offers improved throughput and capacity. The network entity 104 may dynamically reconfigure the UE 102 according to coverage conditions or desired throughput.

The maximum transmission power for the two waveforms may be different due to the higher PAPR or cubic metric (CM) of the CP-OFDM compared to that of the DFT-s-OFDM. Thus, the reporting of reference PHR when there is no scheduled PUSCH transmission with regard to the difference of the maximum transmission power for the two waveforms may present complications. The present disclosure describes techniques to determine the reference PHR with regard to different characteristics of the two waveforms in multi-panel PUSCH transmission.

Furthermore, in CP-OFDM and DFT-s-OFDM based multi-panel PUSCH transmission, especially for PUSCH transmissions scheduled by multiple DCIs associated with different control resource set (CORESET) pool indexes (e.g., CORESET configured with different values of CORESETPoolIndex), the UE 102 may not be able to decode the multiple DCIs to generate in time the indicated PUSCH waveform prior to the scheduled PUSCH transmissions from multiples antenna panels. As a result, the UE 102 may transmit PUSCH from multiple antenna panels with different waveforms. The present disclosure describes techniques to determine the PHR per panel or per CORESET pool, or across all panels or all CORESET pools of the UE 102 when there may be scenarios of identical or different waveforms in uplink multi-panel transmission.

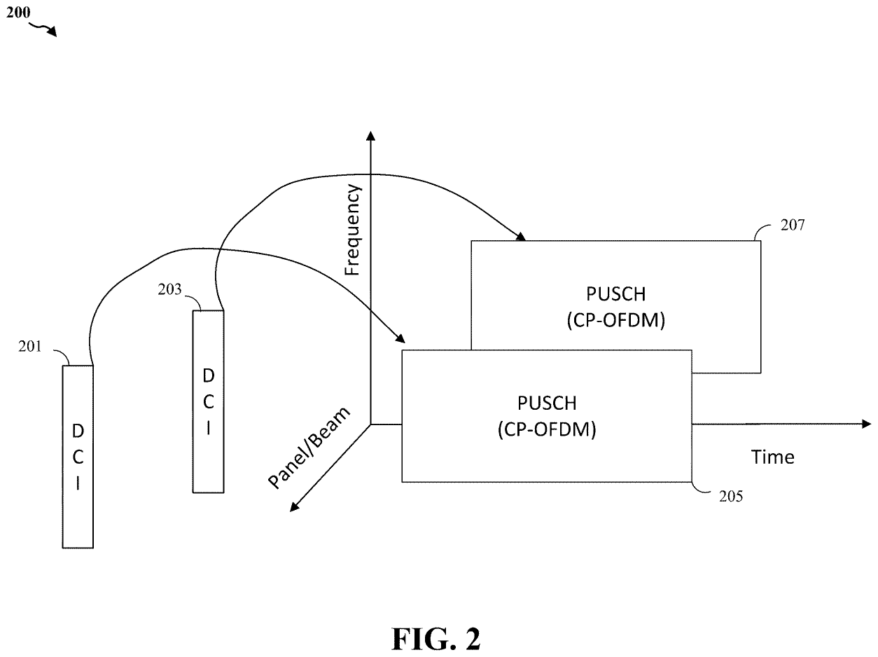

FIG. 2 is a diagram illustrating that a UE 102 is configured to transmit a CP-OFDM waveform from two antenna panels when the UE supports dynamic waveform indication of PUSCH in uplink multi-panel transmission. A first scheduling DCI 201 may configure PUSCH 205 from a first antenna panel to transmit a CP-OFDM waveform. A second scheduling DCI 203 may configure PUSCH 207 from a second antenna panel to also transmit a CP-OFDM waveform. The first DCI and second DCI may be from the CORESETs with different CORESET pools. The UE 102 may support concurrent configuration of dynamic waveform indication and simultaneous multi-panel transmission.

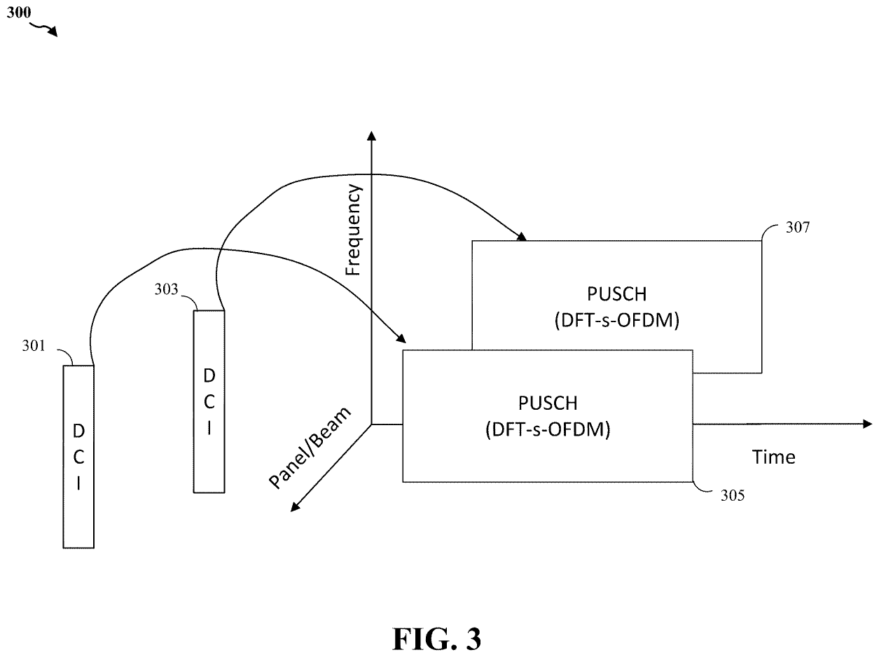

FIG. 3 is a diagram illustrating that a UE 102 is configured to transmit a DFT-s-OFDM waveform from two antenna panels when the UE supports dynamic waveform indication of PUSCH in uplink multi-panel transmission. A first scheduling DCI 301 may configure PUSCH 305 from a first antenna panel to transmit a DFT-s-OFDM waveform. A second scheduling DCI 303 may configure PUSCH 307 from a second antenna panel to also transmit a DFT-s-OFDM waveform.

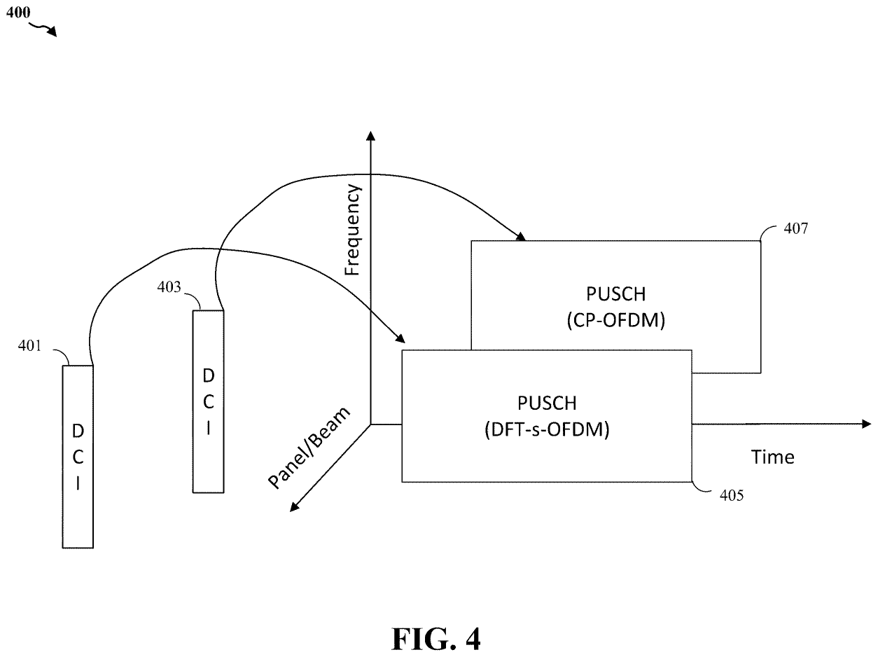

FIG. 4 is a diagram illustrating that a UE 102 is configured to transmit a CP-OFDM waveform from a first antenna panel and to transmit a DFT-s-OFDM waveform from a second antenna panel when the UE supports dynamic waveform indication of PUSCH in uplink multi-panel transmission. A first scheduling DCI 401 may configure PUSCH 405 from a first antenna panel to transmit a DFT-s-OFDM waveform. A second scheduling DCI 403 may configure PUSCH 407 from a second antenna panel to transmit a CP-OFDM waveform.

Aspects of the present disclosure address panel-specific and UE-specific PHR by the UE 102 for dynamic waveform indication of PUSCH in uplink multi-panel transmission. In one aspect, the UE 102 may report the PHR based on a UE-specific maximum uplink transmission power for one or more waveform combinations and the total actual or reference transmission power corresponding to a specific waveform combination from the multiple antenna panels. In some aspects, the UE may calculate and report panel-specific PHR for one or more waveforms for each of the multiple antenna panels. The UE may report the PHR based on the panel-specific maximum uplink transmission power for one or more waveforms and the actual or reference transmission power for a corresponding waveform for each antenna panel.

Advantageously, the techniques described herein may support PHR for different waveform combinations for uplink multi-panel transmission. The network entity 104 may flexibly schedule the bandwidth and waveform for the uplink multi-panel transmission to accommodate various coverage conditions or desired throughput. For example, the network entity 104 may schedule the uplink transmission with higher bandwidth while maintaining the target uplink transmission power below the maximum transmission power constraint to achieve high spectrum efficiency when the uplink transmission uses CP-OFDM waveform. The network entity 104 may also schedule the uplink transmission with higher average power while maintaining the target uplink transmission power below the maximum transmission power constraint to achieve high uplink coverage when the uplink transmission uses DFT-s-OFDM waveform.

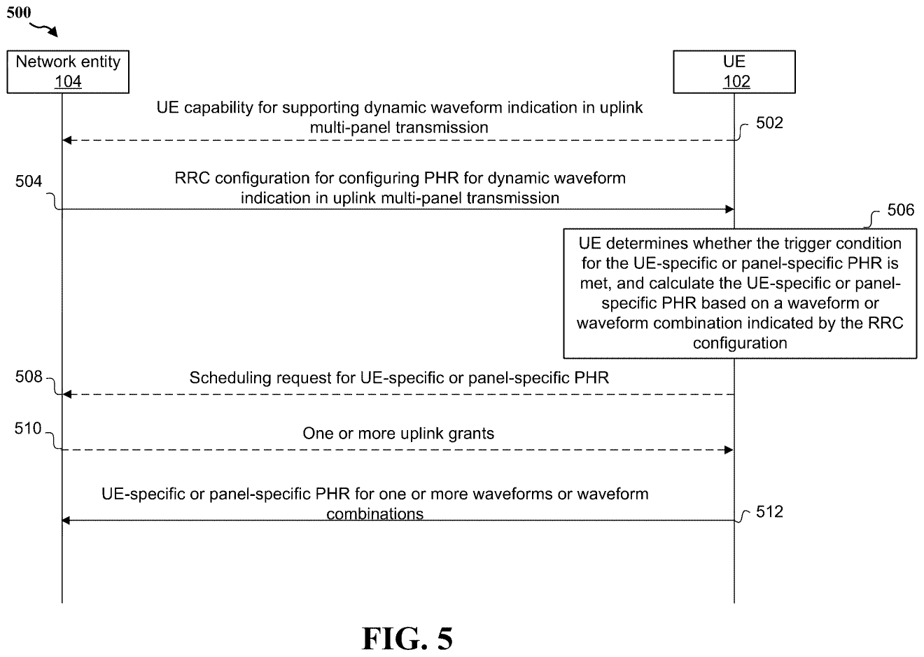

FIG. 5 is a signaling diagram 500 illustrating communications between a UE 102 and a network entity 104 for the UE 102 to report power headroom when the UE 102 supports dynamic waveform indication in uplink multi-panel transmission.

The UE 102 may transmit 502, to the network entity 104, information on capability of the UE 102 for supporting dynamic waveform indication in uplink multi-panel transmission. In one implementation, the UE 102 may report the UE capability indicating the supported configuration(s) for dynamic waveform indication, simultaneous transmission from multiple antenna panels, and PHR calculation and report scheme(s). For example, the UE 102 may report the UE capability indicating whether it supports concurrent configuration of dynamic waveform indication and simultaneous multi-panel transmission. The network entity 104 may configure whether to enable the dynamic waveform indication per panel or per control resource set pool, or across all panels or all control resource set pools.

Based on the received report of UE capability, the network entity 104 may transmit 504, to the UE 102, a Radio Resource Control (RRC) signaling, e.g., RRCReconfiguration, to configure the PHR for dynamic waveform indication in uplink multi-panel transmission. In one implementation, the network entity 104 may configure one or more RRC parameters for simultaneous uplink multiple panel transmission (e.g., configuring two SRS resource sets for codebook or non-codebook based transmission for a bandwidth part or a serving cell) and may configure the multiplexing scheme for the PUSCH from multiple panels (e.g., spatial domain multiplexing (SDM) or single frequency network (SFN)). In one implementation, the network entity 104 may configure one or more RRC parameters to enable the dynamic waveform indication. In one implementation, the network entity 104 may configure one or more RRC parameters for the UE-specific or panel-specific PHR. In one implementation, the network entity 104 may refrain from configuring the uplink simultaneous multi-panel transmission and dynamic waveform indication for a bandwidth part or a serving cell.

Based on the received RRC parameters, the UE 102 may determine 506 whether the triggering condition for the UE-specific or panel-specific PHR is met. If the triggering condition for the UE-specific PHR is met, the UE 102 may calculate one or more UE-specific PHRs for one or more combinations of waveforms from the multiple antenna panels. In one implementation, the UE 102 may calculate the PHRs based on a UE-specific maximum uplink transmission power for one or more waveform combinations and the total actual or reference transmission power corresponding to a specific waveform combination from multiple antenna panels.

If the triggering condition for the panel-specific PHR is met, the UE 102 may calculate one or more panel-specific PHRs for one or more waveforms for each of the multiple antenna panels. The UE 102 may calculate the PHRs based on the panel-specific maximum uplink transmission power for one or more waveforms and the actual or reference transmission power for a corresponding waveform for each antenna panel.

If the UE 102 did not receive an uplink grant, the UE 102 may transmit 508, to the network entity 104, a scheduling request to request the uplink resource for the one or more UE-specific or panel-specific PHRs. In one implementation, the scheduling request may be specific to the UE-specific or the panel-specific PHRs.

In response to the scheduling request, the network entity 104 may transmit 510, to the UE 102, one or more uplink grants such as one or more DCIs to schedule the PUSCH transmission and to allocate resources for the PUSCH transmission.

The UE 102 may transmit 512, to the network entity 104, the UE-specific PHRs for one or more waveforms or the panel-specific PHRs for one or more waveform combinations of the dynamic waveform indication at the scheduled PUSCH transmission. In one implementation, the UE 102 may transmit the UE-specific PHRs or the panel-specific PHRs using MAC-CE of the scheduled PUSCH transmission.

Following is a detailed discussion of how the UE 102 may determine the UE-specific PHRs and the panel-specific PHRs to support dynamic waveform indication in uplink multi-panel transmission.

In one aspect, a UE 102 may report the UE-specific PHR based on the UE-specific maximum uplink transmission power and the total transmission power from multiple panels. In one example, the UE 102 may calculate the actual or reference PH for a waveform combination as follows:

$${PH}^{( w )} = {P}_{c , max}^{( w )} - 10 {log}_{10} {\sum }_{j = 1}^{N} 1 {0}^{0.1 {P}_{T x}^{( {w}_{j} , j )}} \qquad ( Equation 1 )$$

where

$${P}_{c , max}^{( w )}$$

indicates the actual or reference maximum transmission power for a waveform combination;

$${P}_{T x}^{( {w}_{j} , j )}$$

indicates the actual or reference transmission power for waveform wⱼ from panel j or indicated TCI state j; N indicates the number of panels (activated by the UE 102 or equipped in UE 102) or the number of indicated/activated TCI states from the network entity 104.

If the UE 102 has a scheduled PUSCH transmission,

$${P}_{c , max}^{( w )}$$

may indicate the actual maximum transmission power. In one implementation, the actual maximum transmission power may be determined based on a maximum transmission power minus a maximum power reduction for the PUSCH. Otherwise, if the UE 102 does not have a scheduled PUSCH transmission,

$${P}_{c , max}^{( w )}$$

may indicate the reference maximum transmission power. In one implementation, the reference maximum transmission power may be determined based on the maximum transmission power without a power reduction. The actual transmission power may be determined based on the configured uplink power control parameters for the PUSCH. The reference transmission power may be determined based on a default set of power control parameters.

In one aspect, the UE 102 may report the UE-specific PHR according to one waveform combination. The waveform combination may include any combination of the waveforms of the PUSCH from multiple panels. For example, for two panels, the waveform combination may include a CP-OFDM waveform from each of the two panels as shown in the scenario of FIG. 2. In another scenario, the waveform combination may include a DFT-s-OFDM waveform from each of the two panels as shown in FIG. 3. In yet another scenario, the waveform combination may include a CP-OFDM waveform from one panel and a DFT-s-OFDM waveform from another panel as shown in FIG. 4.

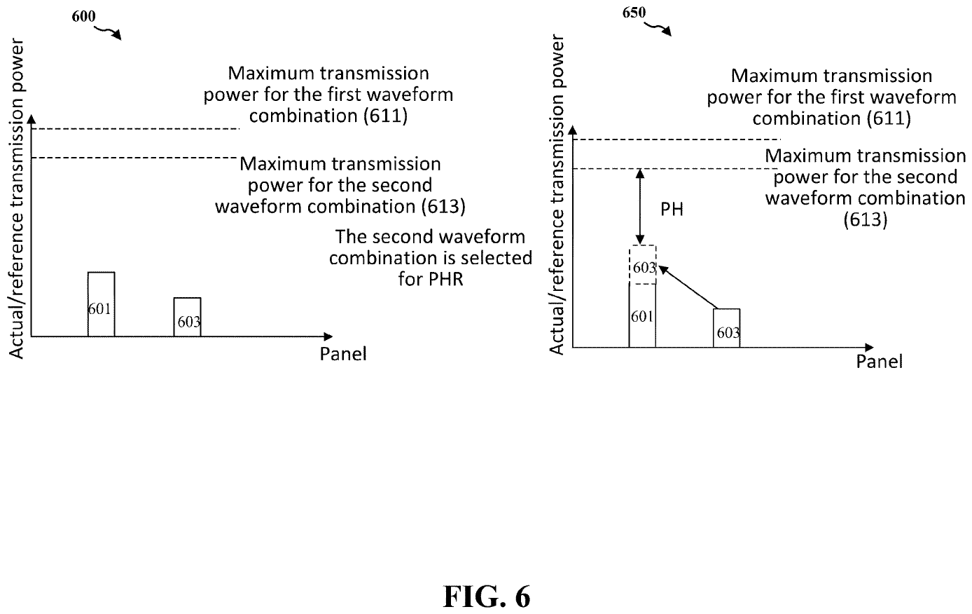

FIG. 6 shows two diagrams 600 and 650 illustrating a single UE-specific PHR based on one combination of waveforms of the dynamic waveform indication from two antenna panels in uplink multi-panel transmission. The network entity 104 may configure a common set or different sets of uplink power control parameters for different waveform combinations.

In one implementation, for actual PHR, the UE 102 may report the UE-specific PHR based on the waveform combination for the actual transmission for the PUSCH from both panels. In one implementation, the UE 102 may report the UE capabilities indicating the supported waveform combinations: e.g., whether the UE supports the waveform combinations of CP-OFDM+CP-OFDM, DFT-s-OFDM+DFT-s-OFDM and/or CP-OFDM+DFT-s-OFDM. In one implementation, with regard to potential miss detection of a scheduling DCI, the UE 102 may report the number of actual transmitted PUSCHs for the PHR calculation for the reported PHR or the index(es) of actual transmitted PUSCH (e.g., TCI state index(es), SRS resource set index(es), or control resource set pool index(es)) for the PHR calculation for the reported PHR. In one implementation, the network entity 104 may refrain from indicating a certain waveform combination. For example, the network entity may refrain from indicating the waveform combination of CP-OFDM+DFT-s-OFDM. In another example, the network entity may refrain from indicating the waveform combination of DFT-s-OFDM+DFT-s-OFDM.

Diagrams 600 and 650 of FIG. 6 display on the x-axis the ordering of the antenna panels of a UE 102 and on the y-axis the strength of the actual or reference transmission power from the antenna panels. Diagram 600 shows that the network entity 104 has configured a maximum transmission power 611 for a first waveform combination and a different maximum transmission power 613 for a second waveform combination. The network entity 104 may schedule the UE 102 to transmit the second waveform combination, which includes the actual transmission power 601 for a first waveform of the scheduled second waveform combination from a first panel and the actual transmission power 603 for a second waveform of the scheduled second waveform combination from a second panel. Referring to diagram 650, the UE 102 may determine the PH for the scheduled second waveform combination by summing the actual transmission power 601 and the actual transmission power 603 from the two panels and using Equation 1 to determine the PH for the second combination based on the sum and the maximum transmission power 613 for the second waveform combination.

In one implementation, for reference PHR, the UE 102 may report the PHR based on pre-defined or configured waveform combination. In one implementation, the network entity 104 may configure the waveform combination for reference PHR calculation by RRC signaling, MAC CE or DCI. In one implementation, the waveform combination for reference PHR calculation may be predefined, e.g., CP-OFDM+CP-OFDM or DFT-s-OFDM+DFT-s-OFDM. In one implementation, the UE 102 may report the supported waveform combination for reference PHR calculation. In one implementation, the UE 102 may report the PHR corresponding to the waveform combination with the maximum or minimum PH or the maximum transmission power.

In one implementation, the UE 102 may report the UE capability or UE assistance information indicating the offset or power backoff for the maximum transmission power for the waveform combinations other than the waveform combination used for the PHR report. The UE 102 may report the UE assistance information by RRC message, MAC CE or uplink control information (UCI). Then with the PHR for one waveform combination, the network entity 104 may calculate the PHR for another waveform combination based on the received UE capability or UE assistance information.

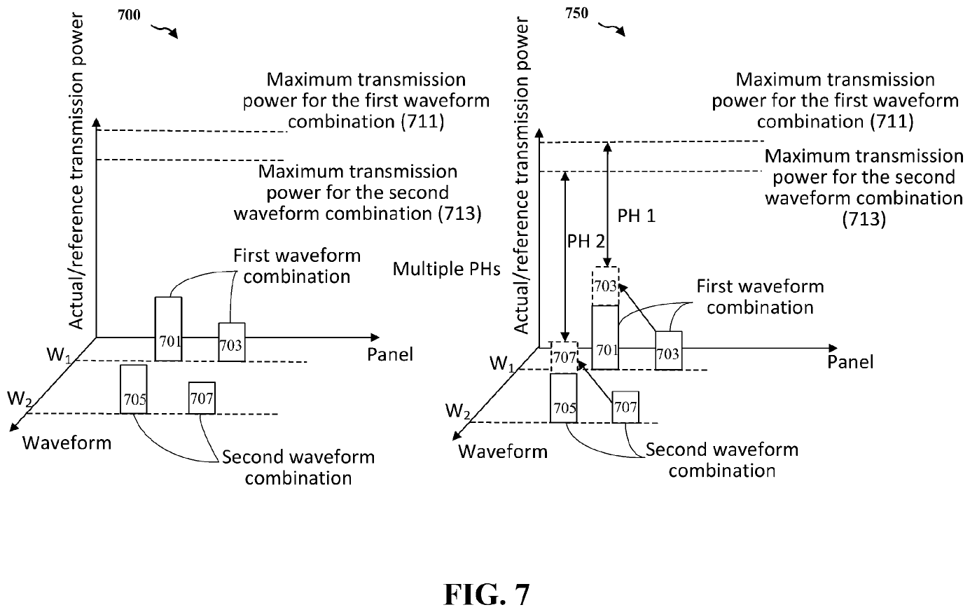

In one aspect, the UE 102 may report multiple UE-specific PHRs based on different waveform combinations. FIG. 7 shows two diagrams 700 and 750 illustrating multiple UE-specific PHRs based on different combinations of waveforms of the dynamic waveform indication from two antenna panels in uplink multi-panel transmission. Diagrams 700 and 750 display on the x-axis the ordering of the antenna panels of a UE 102, on the y-axis the strength of the actual or reference transmission power from the antenna panels, and on a third axis the waveform associated with the transmissions from the antenna panels.

Diagram 700 shows that the network entity 104 has configured a maximum transmission power 711 for a first waveform combination W₁ and a different maximum transmission power 713 for a second waveform combination W₂. The network entity 104 may configure the UE 102 to transmit a first waveform combination W₁ during a scheduled first PUSCH, which includes the actual transmission power 701 for a first waveform of the first waveform combination W₁ from a first panel and the actual transmission power 703 for a second waveform of the first waveform combination W₁ from a second panel. The network entity 104 may configure the UE 102 to transmit a second waveform combination W₂ during a scheduled second PUSCH, which includes the actual transmission power 705 for a first waveform of the second waveform combination W₂ from the first panel and the actual transmission power 707 for a second waveform of the second waveform combination W₂ from the second panel. Referring to diagram 750, the UE 102 may determine the PH1 for the first waveform combination W₁ by summing the actual transmission power 701 and the actual transmission power 703 from the two panels of the first PUSCH and using Equation 1 to determine the PH1 for the first waveform combination W₁ based on the sum and the maximum transmission power 711 for the first waveform combination. The UE 102 may also determine the PH2 for the second waveform combination W₂ by summing the actual transmission power 705 and the actual transmission power 707 from the two panels of the second PUSCH and using Equation 1 to determine the PH2 for the second waveform combination W₂ based on the sum and the maximum transmission power 713 for the second waveform combination.

In one implementation, the UE 102 may report the absolute value of PHR for each waveform combination by a single MAC CE. In one implementation, the UE 102 may report the absolute value of PHR for each waveform combination by separate MAC CEs. In one implementation, the UE 102 may report the absolute value of PHR for one waveform combination and may report the differential value for part of or all PHR(s) for other waveform combination(s). In one implementation, for one PHR, the UE 102 may report the PH and/or the maximum transmission power. In one implementation, the waveform combination for absolute PHR may be predefined, e.g., DFT-s-OFDM+DFT-s-OFDM, or configured by the network entity 104 via RRC signaling, MAC CE or DCI. In one implementation, the network entity 104 may configure whether the UE reports the absolute value or the differential value for the other waveform combination(s). For example, the UE 102 may report the absolute value of PH and maximum transmission power for a waveform combination, e.g., DFT-s-OFDM+DFT-s-OFDM waveform combination, and may report the absolute value or differential value of PH and/or maximum transmission power for another waveform combination, e.g., CP-OFDM+CP-OFDM.

In one implementation, the UE 102 may report the UE capability indicating the supported waveform combinations for PHR. The network entity 104 may configure whether the UE reports a single PHR corresponding to one waveform combination (in FIG. 6) or multiple PHRs for different waveform combinations (in FIG. 7). The network entity 104 may configure a common set or different sets of uplink power control parameters for different waveform combinations. In one implementation, the network entity 104 may configure the waveform combinations for PHR report by RRC signaling, MAC CE or DCI.

In one implementation, the UE 102 may determine the triggering condition for PHR (e.g., PHR prohibit timer, transmission power factor change threshold, periodic PHR report timer, maximum power emission (MPE) timer, MPE threshold, etc.) for each waveform combinations separately. In one implementation, the network entity 104 may configure a common set or separate sets of triggering conditions or parameters for PHR for different waveform combinations. If the triggering condition for PHR(s) for one or more waveform combinations is met, the UE 102 may report the PHR(s) corresponding to the triggered waveform combinations. In one implementation, the UE 102 may report UE capability indicating whether it supports triggering condition for PHR that is specific to a waveform combination. In one implementation, the UE 102 may report indicator(s) indicating the waveform combination(s) for the reported PHR(s). In one implementation, the UE 102 may report the indicator(s) indicating the panel index or TCI index or control resource set pool index for each reported PHR. The UE 102 may trigger the UE-specific PHR for a waveform combination by the occurrence of various events.

In one implementation, the UE 102 may trigger the PHR for a waveform combination if the PHR prohibit timer for the waveform combination or for the UE, (e.g. phr-ProhibitTimer) expires or has expired and the pathloss for a panel, for all panels, or for the UE 102 has changed more than a configured threshold(s) (e.g. phr-Tx-PowerFactorChange dB) for at least one reference signal (RS) used as pathloss reference for one activated Serving Cell of any MAC entity of which the active downlink bandwidth part (BWP) is not dormant BWP since the last transmission of a PHR in this MAC entity when the MAC entity has uplink resources for new transmission.

In one implementation, the UE 102 may trigger the PHR for a waveform combination when the timer for periodic PHR for the waveform combination or for the UE (e.g., phr-PeriodicTimer) expires.

In one implementation, the UE 102 may trigger the PHR for a waveform combination upon configuration or reconfiguration of the power headroom reporting functionality for the waveform combination or for the UE by upper layers (e.g., RRC layer), which is not used to disable the PHR function.

In one implementation, the UE 102 may trigger the PHR for a waveform combination upon activation of a secondary cell (SCell) with multi-panel transmission for the waveform combination or with dynamic waveform indication of any MAC entity with configured uplink of which the parameterfirstActiveDownlinkBWP-Id is not set to dormant BWP.

In one implementation, the UE 102 may trigger the PHR for a waveform combination upon activation of a secondary cell group (SCG) with multi-panel transmission for the waveform combination or with dynamic waveform indication.

In one implementation, the UE 102 may trigger the PHR for a waveform combination upon addition of the primaiy secondaiy cell (PSCell) with multi-panel transmission for the waveform combination or with dynamic waveform indication except if the SCG is deactivated (i.e., PSCell is newly added or changed).

In one implementation, the UE 102 may trigger the PHR for a waveform combination when the PHR prohibit timer for the waveform combination or for the UE (e.g., phr-ProhibitTimer) expires or has expired, when the MAC entity has UL resources for new transmission, and the following condition is true for any of the activated serving cells of any MAC entity with configured uplink. The condition may include when there are UL resources allocated for transmission or there is a PUCCH transmission on this cell, and the required power backoff for the waveform combination or for the UE due to power management for this cell has changed more than a configured threshold (e.g., phr-Tx-PowerFactorChange dB) since the last transmission of a PHR when the MAC entity had UL resources allocated for transmission or PUCCH transmission on this cell.

In one implementation, the UE 102 may trigger the PHR for a waveform combination upon switching of activated BWP from dormant BWP to non-dormant DL BWP of an SCell of any MAC entity with configured uplink.

In one implementation, the UE 102 may trigger the PHR for a waveform combination if the maximum power emission (MPE) related report is enabled (e.g., mpe-Reporting-FR2) is configured, the prohibit timer for the waveform combination or for the UE for MPE report, (e.g., mpe-ProhibitTimer) is not running, and the following condition is true. The condition may include the measured power management power reduction (P-MPR) applied to meet FR2 MPE requirements is equal to or larger than a first configured threshold for the waveform combination or for the UE (e.g., mpe-Threshold) for at least one activated FR2 Serving Cell since the last transmission of a PHR in this MAC entity. The condition may also include the measured P-MPR applied to meet FR2 MPE requirements has changed more than a second configured threshold for the waveform combination or for the UE (e.g., phr-Tx-PowerFactorChange dB) for at least one activated FR2 Serving Cell since the last transmission of a PHR due to the measured P-MPR applied to meet MPE requirements being equal to or larger than the first configured threshold for the waveform combination or for the UE (e.g. mpe-Threshold) in this MAC entity.

In one implementation, the UE 102 may trigger the PHR for a waveform combination when the PHR prohibit timer for the waveform combination or for the UE (e.g., phr-ProhibitTimer) expires or has expired and the PH difference between waveforms for a panel, for all panels, or for the UE has exceeded a configured threshold(s), for at least one RS used as pathloss reference for one activated Serving Cell of any MAC entity of which the active downlink bandwidth part (BWP) is not dormant BWP since the last transmission of a PHR in this MAC entity when the MAC entity has uplink resources for new transmission.

In one implementation, the UE 102 may trigger the PHR for a waveform combination when the PHR prohibit timer for the waveform combination or for the UE (e.g., phr-ProhibitTimer) expires or has expired, and the PH for a panel, for all panels, or for the UE is lower than a configured threshold(s), for at least one RS used as pathloss reference for one activated Serving Cell of any MAC entity of which the active downlink bandwidth part (BWP) is not dormant BWP since the last transmission of a PHR in this MAC entity when the MAC entity has uplink resources for new transmission.

In one aspect, a UE 102 may report the panel-specific PHR based on the panel-specific maximum uplink transmission power for a waveform and the transmission power for the waveform from a panel. In one implementation, the UE 102 may report the maximum uplink transmission power for the PHR calculation for each panel and the PH for each panel. In one example, the UE 102 may calculate the actual or reference PH for a waveform w and panel j as follows:

$$P {H}^{( w , j )} = {P}_{c , max}^{( w , j )} - {P}_{T x}^{( w , j )} \qquad ( Equation 2 )$$

where

$${P}_{c , max}^{( w , j )}$$

indicates the actual or reference maximum transmission power for a waveform w and panel j;

$${P}_{T x}^{( w , j )}$$

indicates the actual or reference transmission power for waveform w from panel j or indicated TCI state j.

If the UE 102 has a scheduled PUSCH transmission from the panel j,

$${P}_{c , max}^{( w , j )}$$

may indicate the actual maximum transmission power for waveform w and panel j. In one implementation, the actual maximum transmission power may be determined based on a maximum transmission power minus a maximum power reduction for the PUSCH. Otherwise, if the UE 102 does not have a scheduled PUSCH transmission,

$${P}_{c , max}^{( w , j )}$$

may indicate the reference maximum transmission power for waveform w and panel j. In one implementation, the reference maximum transmission power may be determined based on the maximum transmission power without a power reduction. The actual transmission power

$${P}_{T x}^{( w , j )}$$

may be determined based on the configured uplink power control parameters for the PUSCH for waveform w and panel j. The reference transmission power may be determined based on a default set of power control parameters.

In one aspect, the UE 102 may report the panel-specific PHRs corresponding to one waveform. The network entity 104 may configure a common set or different sets of uplink power control parameters for different waveforms. The UE 102 may report one PHR per panel, and may report more than one PHRs corresponding to different panels.

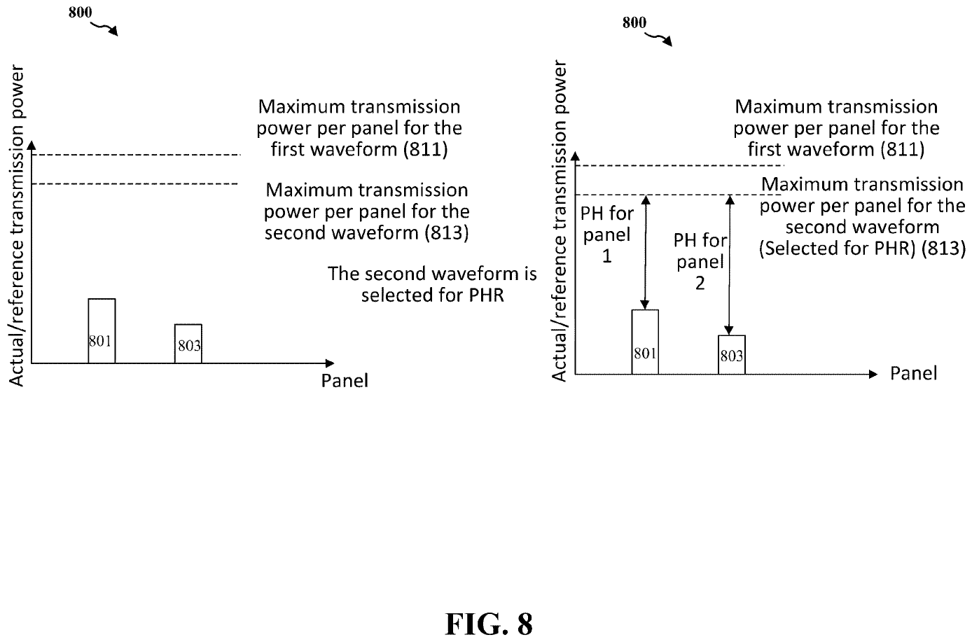

FIG. 8 shows two diagrams 800 and 850 illustrating a single panel-specific PHR based on one waveform of the dynamic waveform indication from each antenna panel in uplink multi-panel transmission. The waveform may be CP-OFDM or DFT-s-OFDM for the PUSCH. Diagrams 800 and 850 display on the x-axis the ordering of the antenna panels of a UE 102 and on the y-axis the strength of the actual or reference transmission power from the antenna panels.

Referring to diagram 800, the network entity 104 may configure a maximum transmission power 811 for a first waveform and a different maximum transmission power 813 for a second waveform. The network entity 104 may also schedule the UE 102 to transmit the second waveform from both panels. For example, the UE 102 may transmit the second waveform from a first panel with the actual transmission power 801 and may transmit the second waveform from a second panel with the actual transmission power 803. Referring to diagram 850, using Equation 2, the UE 102 may determine the PH for the second waveform for panel 1 by subtracting the actual transmission power 801 of the second waveform for panel 1 from the maximum transmission power 813 for the second waveform. Again, using Equation 2, the UE 102 may determine the PH for the second waveform for panel 2 by subtracting the actual transmission power 803 of the second waveform for panel 2 from the maximum transmission power 813 for the second waveform.

In one implementation, the maximum transmission power for a waveform may be the same for each panel. In one implementation, the maximum transmission power for a waveform may be different across multiple panels. In one implementation, the UE 102 may report the maximum transmission power for each panel via UE capability report and/or RRC message (e.g., UE assistance information report). In one implementation, the network entity 104 may configure the maximum transmission power for each panel by RRC signaling, MAC CE or DCI.

In one implementation, for actual PHR, the UE 102 may report the PHR based on the waveform for the actual transmission for the PUSCH from the panel. In some implementations, the UE 102 may report the UE capabilities indicating the supported waveform for panel-specific PHR (e.g., whether the UE 102 supports the PHR for CP-OFDM and/or DFT-s-OFDM).

In one implementation, for reference PHR, the UE 102 may report the PHR based on a pre-defined or configured waveform. In one implementation, the network entity 104 may configure the waveform for reference PHR calculation by RRC signaling, MAC CE or DCI. In one implementation, the waveform for reference PHR calculation may be predefined for CP-OFDM or DFT-s-OFDM. In one implementation, the UE 102 may report the PHR corresponding to the waveform with the maximum or minimum PH or the maximum transmission power.

In one implementation, the UE 102 may report the UE capability or UE assistance information indicating the offset or power backoff for the maximum transmission power per panel for one or more waveforms other than the waveform used for the PHR report. The UE 102 may report the UE assistance information by RRC message, MAC CE or UCI. Then with the PHR for a single waveform, the network entity 104 may calculate the PHR for another waveform based on the received UE capability or UE assistance information.

In one aspect, the UE 102 may report multiple panel-specific PHRs based on different waveforms. The network entity 104 may configure a common set or different sets of uplink power control parameters for different waveforms.

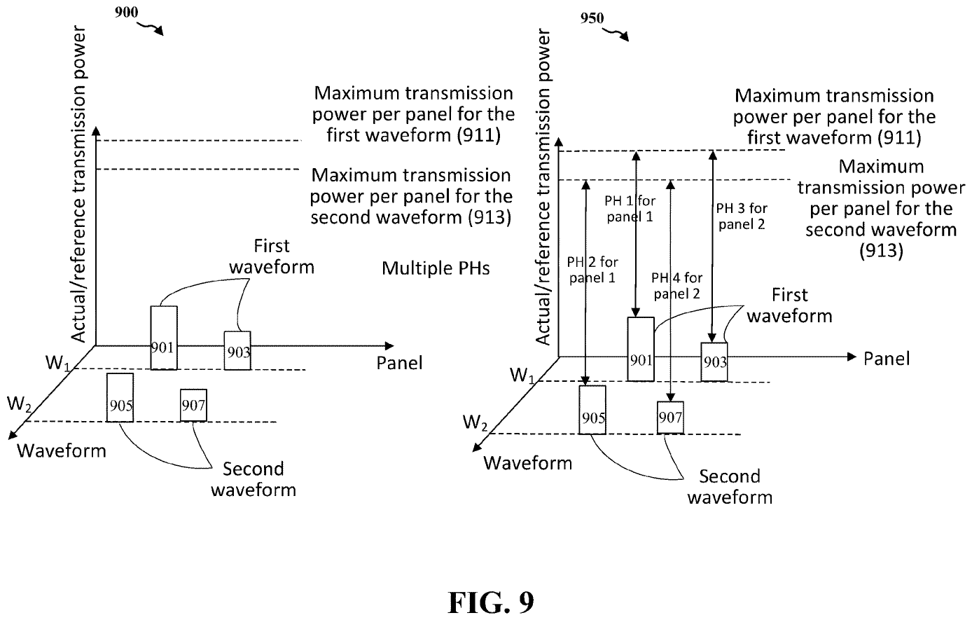

FIG. 9 shows two diagrams 900 and 950 illustrating multiple panel-specific PHRs based on different waveforms of the dynamic waveform indication from each antenna panel in uplink multi-panel transmission. Diagrams 900 and 950 display on the x-axis the ordering of the antenna panels of a UE 102, on the y-axis the strength of the actual or reference transmission power from the antenna panels, and on a third axis the waveform associated with the transmissions from the antenna panels.

Referring to diagram 900, the network entity 104 may configure a maximum transmission power 911 for a first waveform W₁ and a different maximum transmission power 913 for a second waveform W₂. The network entity 104 may schedule the UE 102 to transmit a waveform from both panels during a scheduled first PUSCH and during a scheduled second PUSCH. For example, during the first PUSCH, the UE 102 may be scheduled to transmit the first waveform W₁ from a first panel with the actual transmission power 901 and to transmit the first waveform W₁ from a second panel with the actual transmission power 903. During the second PUSCH, the UE 102 may be scheduled to transmit the second waveform W₂ from the first panel with the actual transmission power 905 and to transmit the second waveform W₂ from the second panel with the actual transmission power 907.

Referring to diagram 950, the UE 102 may determine the PH1 for the first waveform W₁ for the first panel by subtracting the actual transmission power 901 of the first waveform W₁ for the first panel during the first PUSCH from the maximum transmission power 911 for the first waveform using Equation 2. The UE 102 may determine the PH2 for the second waveform W₂ for the first panel by subtracting the actual transmission power 905 of the second waveform W₂ for the first panel during the second PUSCH from the maximum transmission power 913 for the second waveform using Equation 2. The UE 102 may determine the PH3 for the first waveform W₁ for the second panel by subtracting the actual transmission power 903 of the first waveform W₁ for the second panel during the first PUSCH from the maximum transmission power 911 for the first waveform using Equation 2. The UE 102 may determine the PH4 for the second waveform W₂ for the second panel by subtracting the actual transmission power 907 of the second waveform W₂ for the second panel during the second PUSCH from the maximum transmission power 913 for the second waveform using Equation 2.

In one implementation, the UE 102 may report the absolute value of PHR for each waveform for each panel by a single MAC CE. In one implementation, the UE 102 may report the absolute value of PHR for each waveform and/or each panel by separate MAC CEs. In one implementation, the UE 102 may report the absolute value of PHR for one waveform for one panel or per panel and may report the differential value for part of or all PHR for other waveform(s) for the same panel or for all panels. In one implementation, for one PHR, the UE 102 may report the PH and/or maximum transmission power. In one implementation, the waveform for absolute PHR may be predefined, e.g., DFT-s-OFDM or CP-OFDM, or configured by the network entity 104 by RRC signaling, MAC CE or DCI. In one implementation, the network entity 104 may configure whether the UE reports the absolute value or differential value for the other waveform(s).

In one implementation, the UE 102 may report the absolute value of PH and maximum transmission power for a waveform (e.g., DFT-s-OFDM waveform), and may report the absolute value or differential value of PH and/or maximum transmission power for another waveform (e.g., CP-OFDM).

In one implementation, the UE 102 may report the UE capability indicating the supported waveform(s) for PHR. The network entity 104 may configure whether the UE 102 reports a single PHR per panel corresponding to a waveform (in FIG. 8) or multiple PHRs per panel for different waveforms (in FIG. 9). The network entity 104 may configure a common set or different sets of uplink power control parameters for different waveforms. In one implementation, the network entity 104 may configure the waveform(s) for PHR report by RRC signaling, MAC CE or DCI.

In one implementation, the UE 102 may determine the triggering condition for PHR (e.g., PHR prohibit timer, transmission power factor change threshold, periodic PHR report timer, maximum power emission (MPE) timer, MPE threshold, etc.) for each waveform for each panel separately. In one implementation, the network entity 104 may configure a common set or separate sets of triggering conditions or parameters for panel-specific PHR for different waveforms. If the triggering condition for PHR(s) for one or more waveforms from a panel is met, the UE 102 may report the PHR(s) corresponding to the triggered waveforms for the panel. In one implementation, the UE 102 may report UE capability indicating whether it supports triggering condition for PHR that is specific to a waveform. In one implementation, the UE 102 may report indicator(s) indicating the waveform(s) for the reported PHR(s). In one implementation, the UE 102 may report the indicator(s) indicating the panel index or TCI index or control resource set pool index for each reported PHR. The UE 102 may trigger the panel-specific PHR for a waveform by the occurrence of various events.

In one implementation, the UE 102 may trigger the PHR for a waveform if the PHR prohibit timer for the waveform for the panel or for the UE, (e.g. phr-ProhibitTimer) expires or has expired and the pathloss for the panel, for all panels, or for the UE 102 has changed more than a configured threshold(s) (e.g. phr-Tx-PowerFactorChange dB) for at least one reference signal (RS) used as pathloss reference for one activated Serving Cell of any MAC entity of which the active downlink bandwidth part (BWP) is not dormant BWP since the last transmission of a PHR in this MAC entity when the MAC entity has uplink resources for new transmission.

In one implementation, the UE 102 may trigger the PHR for a waveform when the timer for periodic PHR for the waveform for the panel or for the UE (e.g., phr-PeriodicTimer) expires.

In one implementation, the UE 102 may trigger the PHR for a waveform upon configuration or reconfiguration of the power headroom reporting functionality for the waveform for the panel or for the UE by upper layers (e.g., RRC layer), which is not used to disable the PHR function.

In one implementation, the UE 102 may trigger the PHR for a waveform upon activation of a secondary cell (SCell) with multi-panel transmission for the waveform or with dynamic waveform indication of any MAC entity with configured uplink of which the parameterfirstActiveDownlinkBWP-Id is not set to dormant BWP.

In one implementation, the UE 102 may trigger the PHR for a waveform upon activation of a secondary cell group (SCG) with multi-panel transmission for the waveform or with dynamic waveform indication.

In one implementation, the UE 102 may trigger the PHR for a waveform upon addition of the primary secondary cell (PSCell) with multi-panel transmission for the waveform or with dynamic waveform indication except if the SCG is deactivated (i.e., PSCell is newly added or changed).

In one implementation, the UE 102 may trigger the PHR for a waveform when the PHR prohibit timer for the waveform or for the UE (e.g., phr-ProhibitTimer) expires or has expired, when the MAC entity has UL resources for new transmission, and the following condition is true for any of the activated serving cells of any MAC entity with configured uplink. The condition may include when there are UL resources allocated for transmission or there is a PUCCH transmission on this cell, and the required power backoff for the waveform for the panel or for the UE due to power management for this cell has changed more than a configured threshold (e.g., phr-Tv-PowerFactorChange dB) since the last transmission of a PHR when the MAC entity had UL resources allocated for transmission or PUCCH transmission on this cell.

In one implementation, the UE 102 may trigger the PHR for a waveform upon switching of activated BWP from dormant BWP to non-dormant DL BWP of an SCell of any MAC entity with configured uplink.

In one implementation, the UE 102 may trigger the PHR for a waveform if the maximum power emission (MPE) related report is enabled (e.g., mpe-Reporting-FR2 is configured), the prohibit timer for the waveform for the panel or for the UE for MPE report, (e.g., mpe-ProhibitTimer) is not running, and the following condition is true. The condition may include the measured power management power reduction (P-MPR) applied to meet FR2 MPE requirements is equal to or larger than a first configured threshold for the waveform for the panel or for the UE (e.g., mpe-Threshold) for at least one activated FR2 Serving Cell since the last transmission of a PHR in this MAC entity. The condition may also include the measured P-MPR applied to meet FR2 MPE requirements has changed more than a second configured threshold for the waveform for the panel or for the UE (e.g., phr-Tx-PowerFactorChange dB) for at least one activated FR2 Serving Cell since the last transmission of a PHR due to the measured P-MPR applied to meet MPE requirements being equal to or larger than the first configured threshold for the waveform for the panel or for the UE (e.g. mpe-Threshold) in this MAC entity.

In one implementation, the UE 102 may trigger the PHR for a waveform when the PHR prohibit timer for the waveform or for the UE (e.g., phr-ProhibitTimer) expires or has expired, and the PH difference between waveforms for the panel or for all panels has exceeded a configured threshold(s), for at least one RS used as pathloss reference for one activated Serving Cell of any MAC entity of which the active downlink bandwidth part (BWP) is not dormant BWP since the last transmission of a PHR in this MAC entity when the MAC entity has uplink resources for new transmission.

In one implementation, the UE 102 may trigger the PHR for a waveform when the PHR prohibit timer for the waveform or for the UE (e.g., phr-ProhibitTimer) expires or has expired and the PH for a panel or for all panels is lower than a configured threshold(s), for at least one RS used as pathloss reference for one activated Serving Cell of any MAC entity of which the active downlink bandwidth part (BWP) is not dormant BWP since the last transmission of a PHR in this MAC entity when the MAC entity has uplink resources for new transmission.

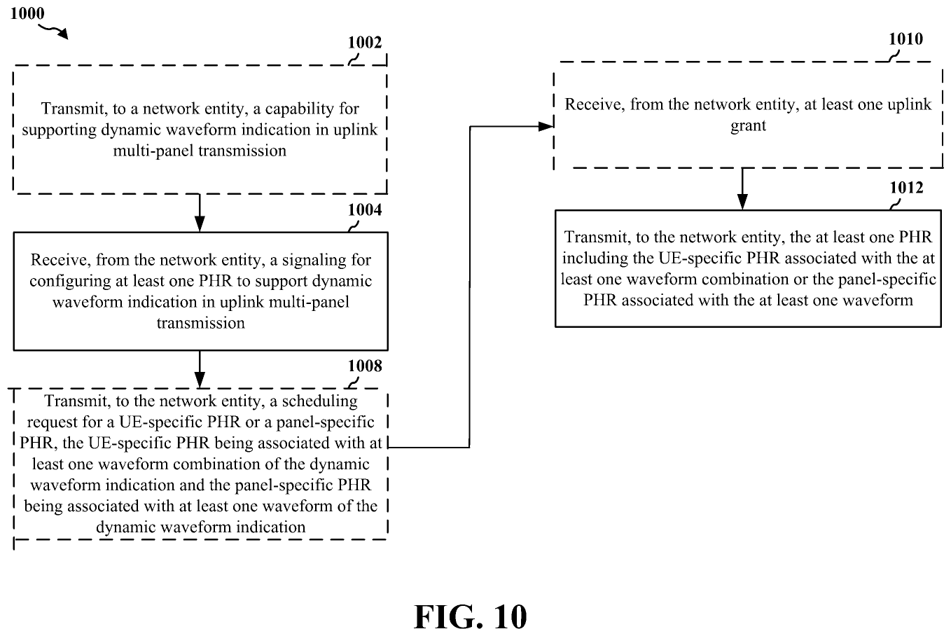

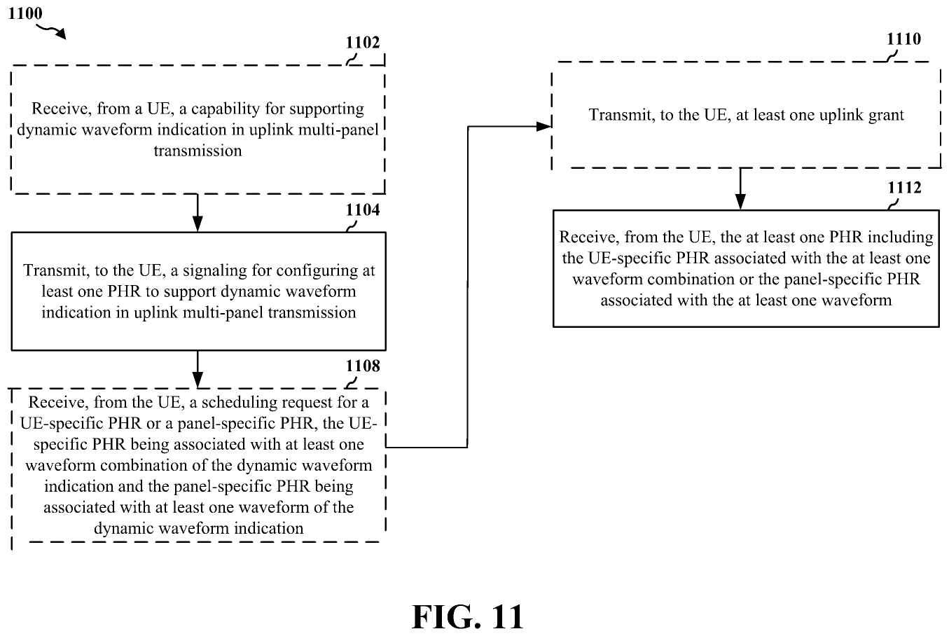

FIGS. 10-11 show methods for implementing one or more aspects of FIGS. 5-9. In particular, FIG. 10 shows an implementation by the UE 102 of the one or more aspects of FIGS. 5-9. FIG. 11 shows an implementation by the network entity 104 of the one or more aspects of FIGS. 5-9.

FIG. 10 is a flowchart of a method 1000 of wireless communication at a UE for reporting power headroom when the UE supports dynamic waveform indication in uplink multi-panel transmission. With reference to FIGS. 1, 5 and 12, the method may be performed by the UE 102, the UE apparatus 1202, etc., which may include the memory 1206′, 1216, 1226′, and which may correspond to the entire UE 102 or the entire UE apparatus 1202, or a component of the UE 102 or the UE apparatus 1202, such as the wireless baseband processor 1226 and/or the application processor 1206.

The UE transmits 1002, to a network entity, a capability for supporting dynamic waveform indication in uplink multi-panel transmission. For example, referring to FIG. 5, the UE 102 transmits 502, to the network entity 104, information on capability of the UE 102 for supporting dynamic waveform indication in uplink multi-panel transmission. In one implementation, the UE 102 may report the UE capability indicating the supported configuration(s) for dynamic waveform indication, simultaneous transmission from multiple antenna panels, and PHR calculation and report scheme(s).

The UE receives 1004, from the network entity, a signaling for configuring at least one PHR to support dynamic waveform indication in uplink multi-panel transmission. For example, referring to FIG. 5, the UE 102 receives 504, from the network entity 104, a RRC signaling, e.g., RRCReconfiguration, to configure the PHR for dynamic waveform indication in uplink multi-panel transmission. In one implementation, the signaling may configure one or more RRC parameters for simultaneous uplink multiple panel transmission (e.g., configuring two SRS resource sets for codebook or non-codebook based transmission for a bandwidth part or a serving cell) and may configure the multiplexing scheme for the PUSCH from multiple panels (e.g., spatial domain multiplexing (SDM) or single frequency network (SFN)). In one implementation, the signaling may configure one or more RRC parameters to enable the dynamic waveform indication. In one implementation, the signaling may configure one or more RRC parameters for the UE-specific or panel-specific PHR.

The UE transmits 1008, to the network entity, a scheduling request for a UE-specific PHR or a panel-specific PHR, the UE-specific PHR being associated with at least one waveform combination of the dynamic waveform indication and the panel-specific PHR being associated with at least one waveform of the dynamic waveform indication. For example, referring to FIG. 5, the UE 102 transmits 508, to the network entity 104, a scheduling request to request the uplink resource for one or more UE-specific or panel-specific PHRs. In one implementation, the scheduling request may be specific to the UE-specific or the panel-specific PHRs. In one implementation, when a triggering condition for the UE-specific PHR is met, the UE 102 may calculate one or more UE-specific PHRs for one or more combinations of waveforms from the multiple antenna panels. In one implementation, when a triggering condition for the panel-specific PHR is met, the UE 102 may calculate one or more panel-specific PHRs for one or more waveforms for each of the multiple antenna panels.

The UE receives 1010, from the network entity, at least one uplink grant. For example, referring to FIG. 5, the UE 102 receives 510, from the network entity 104, one or more uplink grants such as one or more DCIs to schedule the PUSCH transmission and to allocate resources for the PUSCH transmission in response to the scheduling request.

The UE transmits 1012, to the network entity, the at least one PHR including the UE-specific PHR associated with the at least one waveform combination or the panel-specific PHR associated with the at least one waveform. For example, referring to FIG. 5, the UE 102 transmit 512, to the network entity 104, the UE-specific PHRs for one or more waveforms or the panel-specific PHRs for one or more waveform combinations of the dynamic waveform indication at the scheduled PUSCH transmission. In one implementation, the UE 102 may transmit the UE-specific PHRs or the panel-specific PHRs using MAC-CE of the scheduled PUSCH transmission.

FIG. 10 describes a method from a UE-side of a wireless communication link, whereas FIG. 11 describes a method from a network-side of the wireless communication link.

FIG. 11 is a flowchart 1100 of a method of wireless communication at a network entity for receiving a power headroom report when a UE supports dynamic waveform indication in uplink multi-panel transmission. With reference to FIGS. 1, 5 and 12, the method may be performed by one or more network entities 104, which may correspond to a base station or a unit of the base station, such as the RU 106, the DU 108, the CU 110, an RU processor 1306, a DU processor 1326, a CU processor 1346, etc. The one or more network entities 104 may include memory 1306′, 1326′, and 1346′, and may correspond to an entirety of the one or more network entities 104, or a component of the one or more network entities 104, such as the RU processor 1306, the DU processor 1326, or the CU processor 1346.

The network entity receives 1102, from a UE, a capability for supporting dynamic waveform indication in uplink multi-panel transmission. For example, referring to FIG. 5, the network entity 104 receives 502, from the UE, information on capability of the UE 102 for supporting dynamic waveform indication in uplink multi-panel transmission. In one implementation, the UE capability may indicate the supported configuration(s) for dynamic waveform indication, simultaneous transmission from multiple antenna panels, and PHR calculation and report scheme(s).

The network entity transmits 1104, to a UE, a signaling for configuring at least one PHR to support dynamic waveform indication in uplink multi-panel transmission. For example, referring to FIG. 5, the network entity 104 transmits 504, to the UE 102, a RRC signaling, e.g., RRCReconfiguration, to configure the PHR for dynamic waveform indication in uplink multi-panel transmission. In one implementation, the signaling may configure one or more RRC parameters for simultaneous uplink multiple panel transmission (e.g., configuring two SRS resource sets for codebook or non-codebook based transmission for a bandwidth part or a serving cell) and may configure the multiplexing scheme for the PUSCH from multiple panels (e.g., spatial domain multiplexing (SDM) or single frequency network (SFN)). In one implementation, the signaling may configure one or more RRC parameters to enable the dynamic waveform indication. In one implementation, the signaling may configure one or more RRC parameters for the UE-specific or panel-specific PHR.

The network entity receives 1108, from the UE, a scheduling request for a UE-specific PHR or a panel-specific PHR, the UE-specific PHR being associated with at least one waveform combination of the dynamic waveform indication and the panel-specific PHR being associated with at least one waveform of the dynamic waveform indication. For example, referring to FIG. 5, the network entity 104 receives 508, from the UE 102, a scheduling request to request the uplink resource for one or more UE-specific or panel-specific PHRs. In one implementation, the scheduling request may be specific to the UE-specific or the panel-specific PHRs. In one implementation, the one or more UE-specific PHRs may be associated with one or more combinations of waveforms from the multiple antenna panels of the UE 102. In one implementation, one or more panel-specific PHRs may be associated with one or more waveforms for each of the multiple antenna panels of the UE 102.

The network entity transmits 1110, to the UE, at least one uplink grant. For example, referring to FIG. 5, the network entity 104 transmits 510, to the UE 102, one or more uplink grants such as one or more DCIs to schedule the PUSCH transmission and to allocate resources for the PUSCH transmission in response to the scheduling request.

The network entity receives 1112, from the UE, the at least one PHR including the UE-specific PHR associated with the at least one waveform combination or the panel-specific PHR associated with the at least one waveform. For example, referring to FIG. 5, the network entity 104 receives 512, from the UE 102, the UE-specific PHRs for one or more waveforms or the panel-specific PHRs for one or more waveform combinations of the dynamic waveform indication at the scheduled PUSCH transmission. In one implementation, the network entity 104 may receive the UE-specific PHRs or the panel-specific PHRs by MAC-CE of the scheduled PUSCH transmission.

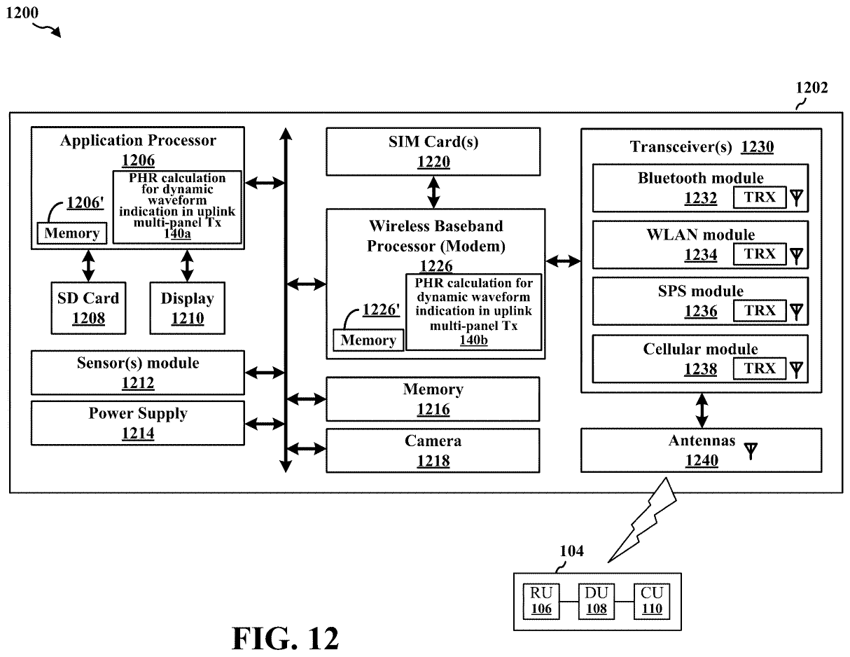

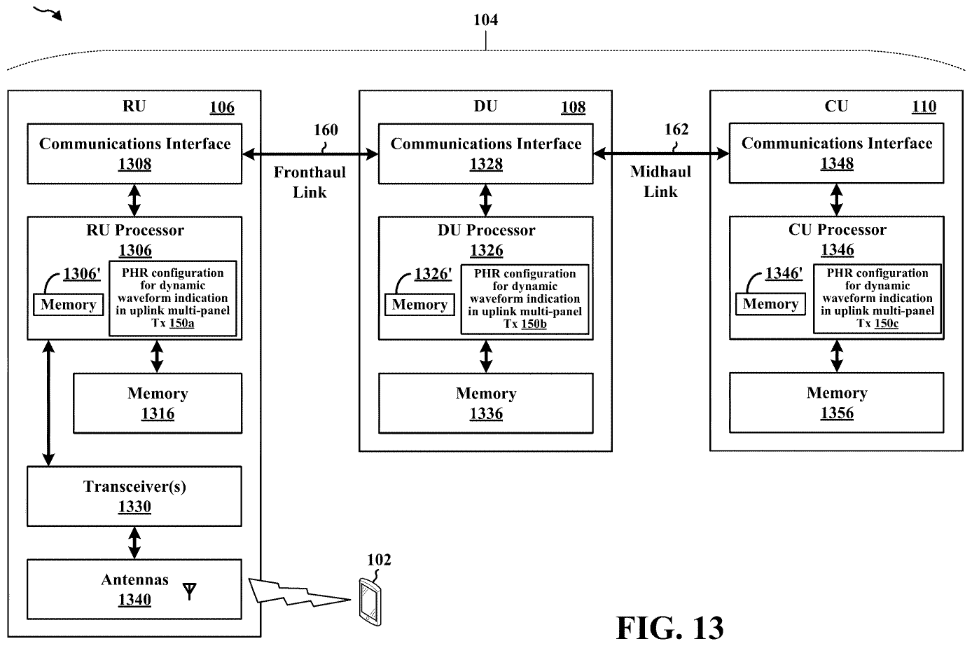

A UE apparatus 1202, as described in FIG. 12, may perform the method of flowchart 1000. The one or more network entities 104, as described in FIG. 13, may perform the method of flowchart 1100.

FIG. 12 is a diagram 1200 illustrating an example of a hardware implementation for a UE apparatus 1202. The UE apparatus 1202 may be the UE 102, a component of the UE 102, or may implement UE functionality. The UE apparatus 1202 may include an application processor 1206, which may have on-chip memory 1206′. In examples, the application processor 1206 may be coupled to a secure digital (SD) card 1208 and/or a display 1210. The application processor 1206 may also be coupled to a sensor(s) module 1212, a power supply 1214, an additional module of memory 1216, a camera 1218, and/or other related components. For example, the sensor(s) module 1212 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1202 may further include a wireless baseband processor 1226, which may be referred to as a modem. The wireless baseband processor 1226 may have on-chip memory 1226′. Along with, and similar to, the application processor 1206, the wireless baseband processor 1226 may also be coupled to the sensor(s) module 1212, the power supply 1214, the additional module of memory 1216, the camera 1218, and/or other related components. The wireless baseband processor 1226 may be additionally coupled to one or more subscriber identity module (SIM) card(s) 1220 and/or one or more transceivers 1230 (e.g., wireless RF transceivers).

Within the one or more transceivers 1230, the UE apparatus 1202 may include a Bluetooth module 1232, a WLAN module 1234, an SPS module 1236 (e.g., GNSS module), and/or a cellular module 1238. The Bluetooth module 1232, the WLAN module 1234, the SPS module 1236, and the cellular module 1238 may each include an on-chip transceiver (TRX), or in some cases, just a transmitter (TX) or just a receiver (RX). The Bluetooth module 1232, the WLAN module 1234, the SPS module 1236, and the cellular module 1238 may each include dedicated antennas and/or utilize antennas 1240 for communication with one or more other nodes. For example, the UE apparatus 1202 can communicate through the transceiver(s) 1230 via the antennas 1240 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1226 and the application processor 1206 may each include a computer-readable medium/memory 1226′, 1206′, respectively. The additional module of memory 1216 may also be considered a computer-readable medium/memory. Each computer-readable medium/memory 1226′, 1206′, 1216 may be non-transitory. The wireless baseband processor 1226 and the application processor 1206 may each be responsible for general processing, including execution of software stored on the computer-readable medium/memory 1226′, 1206′, 1216. The software, when executed by the wireless baseband processor 1226/application processor 1206, causes the wireless baseband processor 1226/application processor 1206 to perform the various functions described herein. The computer-readable medium/memory may also be used for storing data that is manipulated by the wireless baseband processor 1226/application processor 1206 when executing the software. The wireless baseband processor 1226/application processor 1206 may be a component of the UE 102. The UE apparatus 1202 may be a processor chip (e.g., modem and/or application) and include just the wireless baseband processor 1226 and/or the application processor 1206. In other examples, the UE apparatus 1202 may be the entire UE 102 and include the additional modules of the apparatus 1202.

As discussed in FIG. 1 and implemented with respect to FIG. 10, the PHR calculation for dynamic waveform indication in uplink multi-panel transmission component 140 (also referred to as “PHR calculation component 140”) is configured to receive, from a network entity, a signaling for configuring at least one power headroom report (PHR) to support dynamic waveform indication in uplink multi-panel transmission; transmit, to the network entity, the at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

The PHR calculation component 140 may be within the application processor 1206 (e.g., at 140a), the wireless baseband processor 1226 (e.g., at 140b), or both the application processor 1206 and the wireless baseband processor 1226. The PHR calculation component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 13 is a diagram 1300 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1346, which may have on-chip memory 1346′. In some aspects, the CU 110 may further include an additional module of memory 1356 and/or a communications interface 1348, both of which may be coupled to the CU processor 1346. The CU 110 can communicate with the DU 108 through a midhaul link 162, such as an F1 interface between the communications interface 1348 of the CU 110 and a communications interface 1328 of the DU 108.

The DU 108 may include a DU processor 1326, which may have on-chip memory 1326′. In some aspects, the DU 108 may further include an additional module of memory 1336 and/or the communications interface 1328, both of which may be coupled to the DU processor 1326. The DU 108 can communicate with the RU 106 through a fronthaul link 160 between the communications interface 1328 of the DU 108 and a communications interface 1308 of the RU 106.

The RU 106 may include an RU processor 1306, which may have on-chip memory 1306′. In some aspects, the RU 106 may further include an additional module of memory 1316, the communications interface 1308, and one or more transceivers 1330, all of which may be coupled to the RU processor 306. The RU 106 may further include antennas 1340, which may be coupled to the one or more transceivers 1330, such that the RU 106 can communicate through the one or more transceivers 1330 via the antennas 1340 with the UE 102.

The on-chip memory 1306′, 1326′, 1346′ and the additional modules of memory 1316, 1336, 1356 may each be considered a computer-readable medium/memory. Each computer-readable medium/memory may be non-transitory. Each of the processors 1306, 1326, 1346 is responsible for general processing, including execution of software stored on the computer-readable medium/memory. The software, when executed by the corresponding processor(s) 1306, 1326, 1346 causes the processor(s) 1306, 1326, 1346 to perform the various functions described herein. The computer-readable medium/memory may also be used for storing data that is manipulated by the processor(s) 1306, 1326, 1346 when executing the software. In examples, the channel correlation report configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 11, the PHR configuration for dynamic waveform indication in uplink multi-panel transmission component 150 (also referred to as “PHR configuration component 150”) is configured to transmit, to a UE, a signaling for configuring at least one PHR to support dynamic waveform indication in uplink multi-panel transmission; and to receive, from a UE, at least one PHR including a UE-specific PHR or a panel-specific PHR. The UE-specific PHR is associated with at least one waveform combination of the dynamic waveform indication and the panel-specific PHR is associated with at least one waveform of the dynamic waveform indication.

The CSI-RS transmission component 150 may be within one or more processors of the one or more network entities 104, such as the RU processor 1306 (e.g., at 150a), the DU processor 1326 (e.g., at 150b), and/or the CU processor 1346 (e.g., at 150c). The CSI-RS transmission component 150a-150c may be one or more hardware components specifically configured to carry out the stated processes/algorithm, implemented by one or more processors 1306, 1326, 1346 configured to perform the stated processes/algorithm, stored within a computer-readable medium for implementation by the one or more processors 1306, 1326, 1346, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.
Example 1 is a method of wireless communication at a UE, including: receiving, from a network entity, a signaling for configuring at least one power headroom report (PHR) to support dynamic waveform indication in uplink multi-panel transmission; and transmitting, to the network entity, the at least one PHR including a UE-specific PHR or a panel-specific PHR, the UE-specific PHR being associated with at least one waveform combination of the dynamic waveform indication and the panel-specific PHR being associated with at least one waveform of the dynamic waveform indication.
Example 2 may be combined with Example 1 and includes that the signaling configures one or more uplink power control parameters used to determine the UE-specific PHR or the panel-specific PHR.
Example 3 may be combined with Example 1 or 2, and includes that the UE-specific PHR includes a difference between a maximum uplink transmission power for the at least one waveform combination and a total uplink transmission power associated with waveforms of the at least one waveform combination from a plurality of panels of the multi-panel transmission.
Example 4 may be combined with Example 3, and includes that the total uplink transmission power comprises at least one of: a sum of actual transmission power associated with the waveforms of the at least one waveform combination; or a sum of reference transmission power associated with the waveforms of the at least one waveform combination.
Example 5 may be combined with Examples 1, 2 or 3, and includes that the at least one waveform combination includes an identical waveform from the plurality of panels or different waveforms from the plurality of panels.
Example 6 may be combined with Examples 1, 2 or 3, and includes that the UE-specific PHR comprises at least one of: a maximum power headroom (PH) selected from among a plurality of waveform combinations, a minimum PH selected from among the plurality of waveform combinations, or a maximum of the maximum uplink transmission power selected from among the plurality of waveform combinations; a maximum PH selected from among a plurality of waveform combinations and an offset for the maximum uplink transmission power of one of the plurality of waveform combinations not selected for the PHR from the maximum uplink transmission power of the selected waveform combination; a PH associated with a first waveform combination, and a differential value of the PH associated with the first waveform combination and a PH associated with a second waveform combination; or a plurality of UE-specific PHRs associated with different waveform combinations.
Example 7 may be combined with Examples 1, 2 or 3, and includes that the signaling configures whether the UE-specific PHR comprises a PHR associated with a waveform combination or a plurality of PHRs associated with a plurality of waveform combinations.
Example 8 may be combined with Example 1, and includes that the signaling configures a triggering condition for the UE to transmit the UE-specific PHR or the panel specific PHR.
Example 9 may be combined with Example 1, and includes transmitting, to the network entity, a UE capability for supporting the UE-specific PHR or the panel-specific PHR associated with the dynamic waveform indication in uplink multi-panel transmission.
Example 10 may be combined with Example 1, and includes transmitting, to the network entity, a scheduling request for the UE-specific PHR or the panel-specific PHR; and receiving, from the network entity, at least one uplink grant to transmit the UE-specific PHR or the panel-specific PHR.
Example 11 may be combined with Examples 1 or 2, and includes that the panel-specific PHR includes a difference between a maximum uplink transmission power for the at least one waveform and an actual uplink transmission power or a reference uplink transmission power associated with the at least one waveform from a panel of the multi-panel transmission.
Example 12 may be combined with Example 11, and includes that the uplink transmission power includes at least one of: an actual transmission power associated with the at least one waveform from the panel of the multi-panel transmission; or a reference transmission power associated with the at least one waveform from the panel of the multi-panel transmission.
Example 13 may be combined with Examples 1, 2, or 11, and includes that the panel-specific PHR comprises at least one of: one or more power headrooms (PHs) associated one or more different waveforms; a PH associated a first waveform from the panel and a differential value of the PHR associated with the first waveform and a PH associated with a second waveform from the panel; or a plurality of panel-specific PHRs associated with at least one waveform from a plurality of panels of the multi-panel transmission.
Example 14 may be combined with Examples 1, 2, or 11, and includes that the signaling configures whether the panel-specific PHR comprises a PHR associated with the at least one waveform from one panel or from a plurality of panels of the multi-panel transmission.
Example 15 is a method of wireless communication at a network entity, including: transmitting, to a UE, a configuration for a plurality of transmission configuration indicator (TCI) states; transmitting, to the UE, a signaling for configuring at least one power headroom report (PHR) to support dynamic waveform indication in uplink multi-panel transmission; and receiving, from the UE, the at least one PHR including a UE-specific PHR or a panel-specific PHR, the UE-specific PHR being associated with at least one waveform combination of the dynamic waveform indication and the panel-specific PHR being associated with at least one waveform of the dynamic waveform indication.
Example 16 may be combined with Example 15, and includes that the signaling configures one or more uplink power control parameters used to determine the UE-specific PHR or the panel-specific PHR.
Example 17 may be combined with Example 15, and includes receiving, from the UE, a UE capability for supporting the UE-specific PHR or the panel-specific PHR associated with the dynamic waveform indication in uplink multi-panel transmission.
Example 18 may be combined with Example 15, and includes that the signaling configures at least one of: whether the UE-specific PHR comprises a PHR associated with a waveform combination or a plurality of PHRs associated with a plurality of waveform combinations; or whether the panel-specific PHR comprises a PHR associated with the at least one waveform from one panel or from a plurality of panels of the multi-panel transmission.
Example 19 may be combined with Example 15, and includes that the signaling configures a triggering condition for the UE (102) to transmit the UE-specific PHR or the panel specific PHR.
Example 20 is an apparatus for wireless communication, including a memory, a transceiver, and a processor coupled to the memory and the transceiver, the apparatus being configured to implement a method as in any of Examples 1-19.
Example 21 may be combined with Examples 15 or 16, and includes that the UE-specific PHR includes at least one of: a difference between a maximum uplink transmission power for the at least one waveform combination and a total uplink transmission power associated with waveforms of the at least one waveform combination from a plurality of panels of the multi-panel transmission; or a plurality of UE-specific PHRs associated with different waveform combinations.
Example 22 may be combined with Examples 15 or 16, and includes that the signaling configures whether the UE-specific PHR comprises a PHR associated with a waveform combination or a plurality of PHRs associated with a plurality of waveform combinations.
Example 23 may be combined with Example 15, and includes receiving, from the UE, a scheduling request for the UE-specific PHR or the panel-specific PHR; and transmitting, to the UE, at least one uplink grant for the UE to transmit the UE-specific PHR or the panel-specific PHR.
Example 24 may be combined with Examples 15 or 16, and includes that the panel-specific PHR includes at least one of: a difference between a maximum uplink transmission power for the at least one waveform and an actual uplink transmission power or a reference uplink transmission power associated with the at least one waveform from a panel of the multi-panel transmission; or a plurality of panel-specific PHRs associated with at least one waveform from a plurality of panels of the multi-panel transmissions.

What is claimed is:

1. A method of wireless communication at a user equipment (UE), comprising:
receiving, from a network entity, a signaling for configuring at least one power headroom report (PHR) to support uplink multi-panel transmission; and
transmitting, to the network entity, the at least one PHR including a UE-specific PHR or a panel-specific PHR based on the signaling, the UE-specific PHR being associated with at least one waveform combination of the uplink multi-panel transmission and the panel-specific PHR being associated with at least one waveform of the uplink multi-panel transmission.

2. The method of claim 1, wherein the signaling configures one or more uplink power control parameters used to determine the UE-specific PHR or the panel-specific PHR.

3. The method of claim 1, wherein the UE-specific PHR comprises a difference between a maximum uplink transmission power for the at least one waveform combination and a total uplink transmission power associated with waveforms of the at least one waveform combination from a plurality of panels of the uplink multi-panel transmission.

4. The method of claim 3, wherein the total uplink transmission power comprises at least one of:
a first sum of actual transmission power associated with the waveforms of the at least one waveform combination; or
a second sum of reference transmission power associated with the waveforms of the at least one waveform combination.

5. The method of claim 1, wherein the at least one waveform combination includes an identical waveform from a plurality of panels or different waveforms from the plurality of panels.

6. The method of claim 1, wherein the UE-specific PHR comprises at least one of:
a maximum power headroom (PH) selected from among a plurality of waveform combinations, a minimum PH selected from among the plurality of waveform combinations, or a maximum of maximum uplink transmission power selected from among the plurality of waveform combinations;
a maximum PH selected from among the plurality of waveform combinations and an offset for the maximum uplink transmission power of one of the plurality of waveform combinations not selected for the PHR from the maximum uplink transmission power of a selected waveform combination;
a first PH associated with a first waveform combination, and a differential value of the PH associated with the first waveform combination and a second PH associated with a second waveform combination; or
a plurality of UE-specific PHRs associated with different waveform combinations.

7. The method of claim 1, wherein the signaling configures whether the UE-specific PHR comprises a PHR associated with a waveform combination or a plurality of PHRs associated with a plurality of waveform combinations.

8. The method of claim 1, wherein the signaling configures a triggering condition for the UE to transmit the UE-specific PHR or the panel-specific PHR.

9. The method of claim 1, further comprising:
transmitting, to the network entity, a UE capability for supporting the UE-specific PHR or the panel-specific PHR associated with the uplink multi-panel transmission.

10. The method of claim 1, further comprising:
transmitting, to the network entity, a scheduling request for the UE-specific PHR or the panel-specific PHR; and
receiving, from the network entity, at least one uplink grant to transmit the UE-specific PHR or the panel-specific PHR.

11. The method of claim 1, wherein the panel-specific PHR comprises a difference between a maximum uplink transmission power for the at least one waveform and an actual-uplink transmission power associated with the at least one waveform from a panel of the uplink multi-panel transmission.

12. The method of claim 11, wherein the uplink transmission power comprises at least one of:
an actual transmission power associated with the at least one waveform from the panel of the uplink multi-panel transmission; or
a reference transmission power associated with the at least one waveform from the panel of the uplink multi-panel transmission.

13. The method of claim 1, wherein the panel-specific PHR comprises at least one of:
one or more power headrooms (PHs) associated one or more different waveforms;
a first PH associated a first waveform from a panel and a differential value of the PHR associated with the first waveform and a second PH associated with a second waveform from the panel; or
a plurality of panel-specific PHRs associated with the at least one waveform from a plurality of panels of the uplink multi-panel transmission.

14. The method of claim 1, wherein the signaling configures whether the panel-specific PHR comprises a PHR associated with the at least one waveform from one panel or from a plurality of panels of the uplink multi-panel transmission.

15. A method of wireless communication at a network entity, comprising:
transmitting, to a user equipment (UE), a signaling for configuring at least one power headroom report (PHR) to support uplink multi-panel transmission; and
receiving, from the UE, the at least one PHR including a UE-specific PHR or a panel-specific PHR based on the signaling, the UE-specific PHR being associated with at least one waveform combination of the uplink multi-panel transmission and the panel-specific PHR being associated with at least one waveform of the uplink multi-panel transmission.

16. The method of claim 15, wherein the signaling configures one or more uplink power control parameters used to determine the UE-specific PHR or the panel-specific PHR.

17. The method of claim 15, further comprising:
receiving, from the UE, a UE capability for supporting the UE-specific PHR or the panel-specific PHR associated with the uplink multi-panel transmission.

18. The method of claim 15, wherein the signaling configures at least one of:
whether the UE-specific PHR comprises a first PHR associated with a waveform combination or a plurality of PHRs associated with a plurality of waveform combinations; or
whether the panel-specific PHR comprises a second PHR associated with the at least one waveform from one panel or from a plurality of panels of the uplink multi-panel transmission.

19. The method of claim 15, wherein the signaling configures a triggering condition for the UE to transmit the UE-specific PHR or the panel-specific PHR.

20. An apparatus for wireless communication at a user equipment (E), comprising:
a memory;
a transceiver; and
a processor coupled to the memory and the transceiver, the apparatus being configured to:
receive, from a network entity, a signaling for configuring at least one power headroom report (PHR) to support uplink multi-panel transmission, and
transmit, to the network entity, the at least one PHR including a UE-specific PHR or a panel-specific PHR based on the signaling, the UE-specific PHR being associated with at least one waveform combination of the uplink multi-panel transmission and the panel-specific PHR being associated with at least one waveform of the uplink multi-panel transmission.
